(19) United States
(12) Patent Application Publication
(10) Pub. No.: US 2004/0212726 A1
(43) Pub. Date: Oct. 28, 2004

(54) Electronic image-capture module

(76) Inventor: Mu-Jung Wang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/419,837

(22) Filed: Apr. 22, 2003

(51) Int. Cl. H04N 5/225

(52) U.S. Cl. 348/374

(57) ABSTRACT

An electronic image-capture module includes a flexible printed circuit board having an assembly section and a flat cable section which extends from the assembly section, the flat cable section having metal layers formed on both sides in order to prevent electric and magnetic interference (EMI); an image sensor mounted on the first side of the assembly section; a lens mounted on and aligned with the image sensor; an image processing IC mounted on the second side of the assembly section, the image sensor and the image processing IC being mounted on different sides of the assembly section; a connector assembled on the end of the flat cable section to connect to a printed circuit board of an electronic apparatus, such as digital camera; and a serial flash RAM mounted on the assembly section and connected to the image sensor for recording the deficient information, such as the white points, black points and color deviation, of the image sensor in order to have correction and compensation provided by the electronic apparatus.

### BACKGROUND OF THE INVENTION

1. Field of the Invention

The present invention generally relates to an electronic image-capture module which is adaptable to the application of the digital camera and mobile phone, and in particular to an electronic image-capture module which mounted the image sensor and image-processing chip individually on each side of a flexible printed circuit board.

2. The Related Art

The applicable field of an electronic image-capture module is getting broader. The electronic image-capture module can combined with a personal computer and digital camera. The electronic image-capture module is further capable of photographing by a watch or a mobile phone. Conventional digital camera module has been shown in FIGS. 5 and 6. In order to reduce the size of the digital camera module, the image-processing chip is applied to execute the procedure of image-processing instead of the general circuit which is designed for image-processing. The electronic image-capture module 200 has been shown in FIGS. 4 and 5, which comprises a lens 201 and an image sensor 202 to capture an image from an object, an image-processing chip for receiving and processing the image from the image sensor 202. The electronic image-capture module 200 finally connects to a printed circuit board 204 of an applicable electronic apparatus, e.g. digital still camera, and performs the functions which include image-editing and storing. Base on the framework of the electronic image-capture module 200, the image sensor 202 and the image-processing chip 203 are packaged together in the electronic image-capture module 200. Because of the sophistication of the image sensor 202 and the image-processing chip 203 and the requirement of the processes and technology for utilizing the multi-chip package to combine the image sensor 202 and the image-processing chip 203, those demands cause the lower yield of the manufacture and the higher cost of the electronic image-capture module 200.

After manufacture of the electronic image-capture module accomplished, the contact pins of the electronic image-capture module will be mounted in the predetermined holes of a printed circuit board of the electronic apparatus. If the predetermined holes of the printed circuit board are through holes, the Surface Mounting Technology (SMT) is applied to solder the electronic image-capture module on the printed circuit board. As a result of sophistication of the contact pins pertaining to the chip, there will get more faults of product in fabrication. The failed products make the electronic image-capture module damages and cause the loss of money. When the printed circuit board with many layers, it means that the mounted holes are not the through holes, it soldered by Ball Grid Array (BGA) technology. The higher requirement of BGA processes and equipments cause the lower yield of product, and it takes more costs because the products inspection can not depend on the human visual. In conclusion, the unsuitable design of the conventional electronic image-capture module will causes more difficulties in fabrication and lower yield of products, and there is profitless in productivity resulted from broken products and high cost.

### SUMMARY OF THE INVENTION

An object of the present invention is to provide an electronic image-capture module comprising a flexible printed circuit board, an image sensor and an image-processing chip mounted individually on the each side of the flexible printed circuit board, a lens set on the image sensor, and flat cables extended from the flexible printed circuit board for mounting a connector which is adaptable to connect the printed circuit board of an electronic apparatus. The present invention leads a simple way in fabrication of the electronic image-capture module and improves the yield of products. In case of product failure occur in any step of the processes, there will be detected in time. Thus, the cost of products can be controlled efficiently.

Another object of the present invention is to provide an electronic image-capture module, wherein the end of the flat cables extended from flexible printed circuit board is mounted with a connector. The connector is adapted to connecting the predetermined connector set on a printed circuit board of an electronic apparatus. The connector of electronic image-capture module and the connector of the electronic apparatus can be connected in a simple way, and the predetermined area in electronic apparatus for mounting the electronic image-capture module can be allowed to leave each other within a range. In general, the flexible printed circuit board can be bent to about 50 degrees in upside and downside directions. The present invent provides a high adaptability for designing an electronic apparatus with an electronic image-capture module.

A further object of the present invention is to provide an electronic image-capture module, wherein the both sides of the flat cables of the flexible printed circuit board which be coated with metal layers. The flat cables with metal layers can resist the electric and magnetic interference (EMI) of electrical signals. In order to maintain the accuracy of the electrical signals transmitted by flat cables, the metal layers coated on flat cables bring a practical effect of resisting the EMI.

A still further object of the present invention is to provide an electronic image-capture module, wherein the assembly section of the flexible printed circuit board also comprises a serial flash RAM (SFR). The image sensor has some imperfections commonly, e.g. pixel defects with white spots or black spots and the deviation of frequency and color of pictures. The characters of the image sensor can be recorded in the serial flash RAM (SFR) while the inspection after the assembly of the electronic image-capture module, and the characters of the image sensor can be provided to correct and compensate for the pixel defects of the image sensor.

The above and other objects, features and advantages in accordance with the present invention will become apparent from the following detailed description of preferred embodiments of the present invention, and taken in conjunction with the accompanying drawings.

### BRIEF DESCRIPTION OF THE DRAWINGS

The present invention will be apparent to those skilled in the art by reading the following description of a preferred embodiment thereof, with reference to the attached drawings, in which:

FIG. 1 is a top view of an electronic image-capture module in accordance with the present invention;

FIG. 2 is a cross-sectional view of the electronic image-capture module of the present invention;

FIG. 3 is a bottom view of the electronic image-capture module of the present invention;

FIG. 4 is an enlarged cross-sectional view of the flat cables of the electronic image-capture module;

FIG. 5 is a cross-sectional view of the first embodiment of conventional electronic image-capture module; and

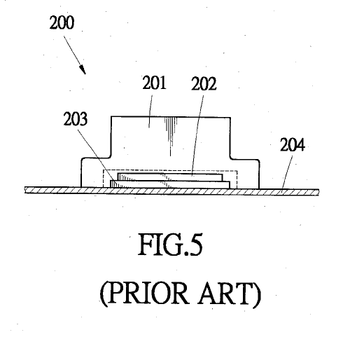

FIG. 6 is a cross-sectional view of the second embodiment of conventional electronic image-capture module.

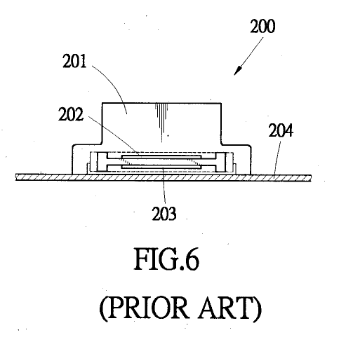

### DETAILED DESCRIPTION OF THE PREFERRED EMBODIMENT

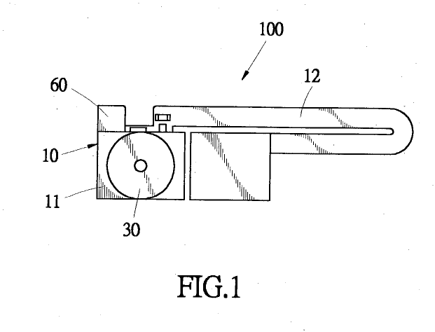

With reference to the drawings and in particular to FIGS. 1-3, an electronic image-capture module of the present invention, generally designated with reference numeral 100, which comprises a flexible printed circuit board 10 having an assembly section 11 and a flat cable 12, the flat cable 12 is extended from the assembly section 11.

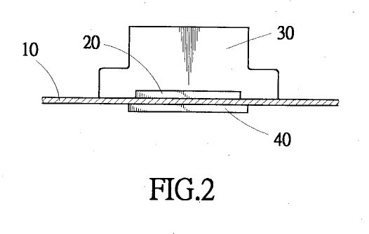

An image sensor 20 is mounted on the first side of the assembly section 11 of flexible printed circuit board 10 (shown in FIG. 1 and FIG. 2). A lens 30 is set on the upside of the image sensor 20 and aligned its optic axis with the optic axis of the image sensor 20. The aspheric lens is adopted in the lens 30 such that the thickness of the lens 30 is merely about 5 millimeter and the size of the module can be minimized. In general cases, the image sensor 20 is soldered on the flexible printed circuit board 10, and the lens 30 is covered on image sensor 20 then combined by adhesive.

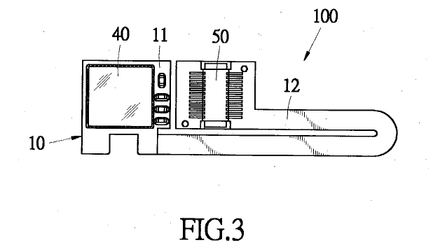

An image-processing chip 40 is mounted on the second side of the assembly section 11 of flexible printed circuit board 10 (shown in FIG. 2 and FIG. 3). As a result of the image sensor 20 and the image-processing chip 40 are mounted separately on different sides of the assembly section 11, the sensor 20 and the chip 40 will not interfere each other. For the same reason, the fabrication of the electronic image-capture module 100 becomes easy and the yield is improved, and in case of error occurred in any step of fabrication, the fabrication can be stopped immediately such that the material loss can be reduced effectively.

A connector 50 is mounted on the end of the flat cable 12 of the flexible printed circuit board 10. The connect 50 is used to connect with a connector of a printed circuit board of an applicable electronic apparatus. The image signals transmitted from the electronic image-capture module 100 through the connector 50 into the electronic apparatus. The flat cable 12 of the flexible printed circuit board 10 is accommodated to the requirement of different lengths and bended angles, for example, the flat cable 12 can be bended upward or downward in a range of 50 degrees. The flat cable 12 is provided in design and used with good flexibility.

Thus, the image is captured by the lens 30 and the image sensor 20, and then the image signals are processed and formed into digital signals by the image-processing chip 40. The digital signals are transmitted through the flat cable 12 and the connector 50 into the electronic apparatus and the digital image is obtained.

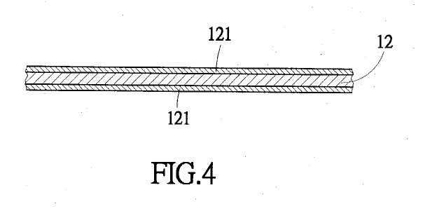

Furthermore, the electronic image-capture module 100 in accordance with the present invention has a flexible printed circuit board 10 and a flat cable 12. The flat cable 12 is provided with the function of signal transmission. As the general electronic apparatus, the electric and magnetic interference (EMI) may occur often. The flat cable 12 of the present invention is coated with metal layers 121 (shown in FIG. 4) on both sides to prevent the EMI within the electronic component of electronic apparatus.

Referring to FIG. 1, the electronic image-capture module 100 of the present invention further comprises a flash memory, e.g. a serial flash RAM (SFR) 60, which is mounted on the assembly section 11 of the flexible printed circuit board 10 and connected with the image sensor 20. The serial flash RAM 60 is stored of the deficient information of the image sensor 20. The deficient information is generated while the inspection by comparing the image signal of the image sensor 20 with the accurate image signals after manufacturing. The characteristic information of the image sensor 20 stored in the serial flash RAM 60 can be utilized to correct the defect, such as the white points, black points and color deviation, of the image signals captured from the image sensor 20.

The size of the electronic image-capture module 100 of the present invention can be smaller below 9×12×7 mm not including the flat cable 12 (flat cable 12 has the customized length by demand). The present invention has advantages of manufacturing easily, low requirement of fabricative techniques and high flexibility of applicability. The present invention can be applied in many electronic apparatuses, e.g. personal computers (PC), digital cameras, watches, mobile phones, palm PCs and personal digital assistants (PDA) etc. The aforementioned electronic apparatuses can be provided with the photographic function by the image-capture module 100 of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electronic image-capture module comprising:
a flexible printed circuit board, the flexible printed circuit board having an assembly section and a flat cable section;
an image sensor being mounted on the first side of the assembly section of the flexible printed circuit board;
a lens being mounted on the image sensor and aligned its optic axis with the optic axis of the image sensor;
an image-processing chip being mounted on the second side of the assembly section of the flexible printed circuit board; and
a connector being mounted on the end of the flat cable of the flexible printed circuit board, the connector being connected to a connector of a printed circuit board of an adapted electronic apparatus.

2. The electronic image-capture module as claimed in claim 1, wherein the flat cable section is coated with metal layers on both sides.

3. The electronic image-capture module as claimed in claim 1, wherein the lens is an aspheric lens.

4. The electronic image-capture module as claimed in claim 2, wherein the metal layers are copper foils.

5. The electronic image-capture module as claimed in claim 1, further comprising a flash memory which is connected to the image sensor.
